(19) United States
(12) Patent Application Publication
(10) Pub. No.: US 2015/0296744 A1
(43) Pub. Date: Oct. 22, 2015

(54) AUTOMATIC WATERING SYSTEM AND METHOD FOR EFFICIENTLY HEATING AND CIRCULATING WATER

(71) Applicant: Ahrens Agricultural Industries, Inc. D/B/A Miraco Livestock Water Systems, Grinnell, IA (US)

(72) Inventors: Philip E. Chumbley, Aurora, IL (US); Michael G. Witt, Grinnell, IA (US)

(73) Assignee: AHRENS AGRICULTURAL INDUSTRIES, INC. D/B/A MIRACO LIVESTOCK WATER SYSTEMS, GRINNELL, IA (US)

(21) Appl. No.: 14/256,129

(22) Filed: Apr. 18, 2014

(51) Int. Cl. A01K 7/02

(52) U.S. Cl. CPC A01K 7/027; A01K 7/025

(57) ABSTRACT

An automatic watering system may include a water-retaining vessel defining a water-retention chamber, and a partition positioned within the water-retaining vessel. The partition separates the water-retaining chamber into a valve chamber and a drinking chamber. The partition may include a first water passage at a first level and a second water passage at a second level that differs from the first level. A valve may be operatively connected to a water supply outlet within the valve chamber. The valve is configured to be moved between an open position in which the water supply outlet is opened, and a closed position in which the water supply outlet is closed. A deicer may be disposed within one of the valve and drinking chambers. The deicer is configured to heat the water within both the valve and drinking chambers.

### BACKGROUND OF THE DISCLOSURE

Embodiments of the present disclosure generally relate to an automatic water system, such as an automatic waterer, and, more particularly, to an automatic watering system that is configured to efficiently heat water within a water-retaining vessel, such as a livestock water tank.

In various settings, water is provided to livestock. For example, a farmer provides water to livestock grazing in pastures, pens, or the like. While a human being may consume less than a gallon of liquid per day, various livestock, such as horses, may drink upwards of 15 gallons in a day.

A typical livestock water tank may retain from 100 to 300 gallons. However, a herd of livestock may quickly drink the water within a particular tank. As such, an individual may need to refill the tank frequently. However, the process of refilling the water tank may be time-consuming. Accordingly, automatic water-filling systems and methods (such as automatic waterers) have been developed. Typically, an automatic waterer includes a float valve operatively connected to a water supply so that when a water level within the tank drops below a certain level, the float valve opens and the tank is refilled.

Water tanks may be positioned outdoors, such as within a grazing pasture, feed pen, or the like. As can be appreciated, outside temperatures may be below freezing at certain times of the year. As such, water within a water tank, trough, or the like may be heated to prevent the water from freezing.

Electric water deicers may be used to keep areas of livestock water tanks and ponds free from ice during winter months. Deicers typically include a temperature sensor (e.g., a thermostat) that detects when the water temperature rises above a freezing point. A typical deicer then deactivates a heating element when water is not susceptible to freezing in order to conserve energy. When the temperature sensor detects that the water temperature is at or close to the freezing point, the deicer re-activates the heating element in order to heat the water.

One type of heated watering system includes a float chamber that is separate and distinct from the drinking trough. The float valve is secured within the float chamber and is separated from the drinking trough by a partition, for example. In general, an opening may be formed through the partition to allow water to pass therethrough. In another known system, a partial partition is formed between the float chamber and the drinking trough. In a float valve watering system, not only does the water within the drinking trough need to be kept from freezing, but the water within the float chamber also needs to be heated to ensure that the float valve does not freeze over.

It has been found, however, that a typical watering system does not efficiently heat water within a drinking trough and a float chamber.

### SUMMARY OF THE DISCLOSURE

Embodiments of the present disclosure are configured to efficiently heat water within and through a water-retaining vessel in order to prevent ice from forming in a drinking chamber and a valve chamber.

Certain embodiments of the present disclosure provide an automatic watering system that may include a water-retaining vessel including a base connected to an upstanding wall. A water-retention chamber is defined between the base and the upstanding wall. The water-retaining vessel is configured to retain water within the water-retaining chamber. A partition is positioned within the water-retaining vessel. The partition separates the water-retaining chamber into a valve chamber and a drinking chamber. The partition includes a first water passage at a first level and a second water passage at a second level that differs from the first level. A valve may be operatively connected to a water supply outlet within the valve chamber. The valve is configured to be moved between an open position in which the water supply outlet is opened, and a closed position in which the water supply outlet is closed. A deicer may be positioned within one of the valve and drinking chambers. The deicer is configured to heat the water within both the valve and drinking chambers.

The second level may be above the first level. In at least one embodiment, the first level extends from an upper surface of the base to a lower edge of a separating panel of the partition. The second level may extend from a first height that is above a water outlet of the deicer to a second height that is below the water supply outlet. In at least one embodiment, the second water passage is located such that it is configured to be completely submerged by the water when the water is at a lowest level prior to the valve moving to the open position.

The deicer may be a sinking deicer including a heating element operatively connected to a thermostat. Alternatively, the deicer may be a floating deicer, plug deicer, or fixed deicer that is affixed to a portion of the water-retaining vessel.

One or both of the first and second water passages may include one or more linear openings formed through the partition. Optionally, one or both of the first and second water passages may include one or more arcuate openings (such as circular, elliptical, oval, semi-circular, or otherwise curved openings) formed through the partition.

In at least one embodiment, the system may include one or more screens positioned on, over, or within one or both of the first and second water passages. In at least one embodiment, the system may include one or both of a first water transfer conduit that extends from the first water passage to a water inlet of the deicer, or a second water transfer conduit that extends from a water outlet of the deicer to the second water passage.

Certain embodiments of the present disclosure provide an automatic watering system that may include a water-retaining vessel including a base connected to an upstanding wall. A partition may be positioned within the water-retaining vessel. The partition separates a water-retaining chamber into a valve chamber and a drinking chamber. The partition includes a lower water passage at a first level and an upper water passage at a second level that is above the first level.

Certain embodiments of the present disclosure provide a water-retaining vessel including a base connected to an upstanding wall. A water-retention chamber is defined between the base and the upstanding wall. The water-retaining vessel is configured to retain water within the water-retaining chamber. A partition is positioned within the water-retaining vessel. The partition separates the water-retaining chamber into a valve chamber and a drinking chamber. The partition includes at least one water passage having a first portion at a first level and a second portion at a second level that is above the first level. For example, a single water passage may have a first portion that is at or above a level of an outlet of a deicer within the valve chamber, and a second portion that is at or below a level of an inlet of a deicer. The first portion may be at a first height, while the second portion may be at a second height which is above or below the first height. The deicer outlet may be on top of the deicer, while the inlet is at a lower portion of the deicer, or vice versa, for example. Optionally, the at least one water passage may include two separate and distinct water passages separated by an intermediate panel, for example.

The water passage(s) may be configured to circulate the water through the first portion and the second portion in a unidirectional loop. For example, water may be circulated from the valve chamber through the second portion of a single water passage into the drinking chamber, and then return from the drinking chamber through the first portion of the single water passage back to the valve chamber. Alternatively, water may be circulated from the valve chamber through the first portion of the single water passage into the drinking chamber, and then return from the drinking chamber through the second portion of the single water passage back to the valve chamber.

### BRIEF DESCRIPTION OF THE DRAWINGS

FIG. 1 illustrates a perspective top view of an automatic watering system, according to an embodiment of the present disclosure.

FIG. 2 illustrates a top plan view of an automatic watering system, according to an embodiment of the present disclosure.

FIG. 3 illustrates a transverse cross-sectional view of an automatic watering system through line 3-3 of FIG. 2, according to an embodiment of the present disclosure.

FIG. 4 illustrates a front view of a partition of an automatic watering system, according to an embodiment of the present disclosure.

FIG. 5 illustrates a front view of a partition of an automatic watering system, according to an embodiment of the present disclosure.

FIG. 6 illustrates a front view of a partition of an automatic watering system, according to an embodiment of the present disclosure.

FIG. 7 illustrates a front view of a partition of an automatic watering system, according to an embodiment of the present disclosure.

FIG. 8 illustrates a front view of a partition of an automatic watering system, according to an embodiment of the present disclosure.

FIG. 9 illustrates a transverse cross-sectional view of a deicer in relation to a partition of an automatic watering system, according to an embodiment of the present disclosure.

FIG. 10 illustrates a transverse cross-sectional view of a deicer in relation to a partition of an automatic watering system, according to an embodiment of the present disclosure.

FIG. 11 illustrates a perspective top view of an automatic watering system, according to an embodiment of the present disclosure.

FIG. 12 illustrates a perspective top view of an automatic watering system, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and proceeded with the word “a” or “an” should be understood as not excluding plural of the elements or steps, unless such exclusion is explicitly stated. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

In any body of water, heat is transferred primarily through convection, as opposed to conduction. An automatic watering system may include a float mechanism contained in a float chamber that is separate and distinct from a drinking trough. A partition may extend between the float chamber and the drinking trough. A water passage may be formed proximate to the base of the tank, thereby providing a water passage between the drinking trough and the float chamber. A deicer placed within either the drinking trough or the float chamber may be incapable of preventing water within the drinking trough and the float chamber from freezing. For instance, if the deicer is positioned on a base of the tank within the valve chamber, the water around the deicer is heated, which causes the heated water to expand, become lighter, and rise to the surface. The heated water displaces colder water from directly above the deicer thereby establishing a natural flow within the float chamber.

However, water may not be pulled from the drinking trough because the water would have to be replaced by water from the float chamber and there may not be sufficient buoyant force from heated water in the drinking trough to displace the water within the float chamber. Therefore, the heated water within the valve chamber may continue to flow directly upward as the float chamber is gradually filled with warm water. Then, the warmed water may spill under the partition and into the drinking trough, with the warm water rising to the top surface where it displaces colder water that then circulates back to the deicer.

However, water turbulence may be generated within the water passage as the warm water flows out while colder water flows in through the water passage. While the lighter, warm water lies on top of the colder water, there is still significant resistance to flow. The result is that the water passage may form a bottleneck causing heated water to congregate around the deicer because the outlet of the water passage is restricted. The blocked, heated water is then heated even more and can trip the thermostat in the deicer causing it to deactivate before enough heat has been delivered to the drinking trough. Therefore, while the float chamber may be warm, ice may form in the drinking trough, thereby preventing animals from drinking from the drinking trough.

Additionally, the physical size of the deicer may be such that its thermostat is located at or near the level of a lower edge of the partition that defines the water passage. In this case, the warmed water in the float chamber causes the deicer to deactivate before the warm water reaches low enough to spill under the partition into the water passage. Therefore, little to no heated water reaches the drinking trough, thereby causing water therein to freeze.

Automatic watering systems may be constructed with insulated walls and the valve chamber may be covered with an insulated cover. By enclosing and insulating the float chamber, the heated water inside the float chamber imparts heat to the air above the water and under the cover, thereby reducing the risk of the water valve and float assembly freezing. However, because the drinking trough may not be covered (in order to provide access to animals), the amount of heat loss within the drinking trough and the float chamber may dramatically vary. Further, the drinking trough may be larger than the valve chamber, which provides greater water surface area, and may result in even greater heat loss. Therefore, even if some heated water enters the drinking trough, the heated water may not be capable of countering the heat loss to ambient air. As such, the temperature of the water within the drinking trough may continue to drop, and ice may form therein.

In order to compensate for the greater heat loss in the drinking trough, one option is to set the deicer to activate and deactivate at higher temperatures than what would normally be used. Most heat loss in a water tank occurs at the boundary between the water and the air. As the water cools it contracts slightly thereby becoming denser and heavier and sinks to the bottom of the tank displacing the slightly warmer water at the bottom. The slightly warmer water is forced to the surface where it is cooled by the air, and then sinks back down. This process continues until the water in the tank reaches a temperature of 4° C., for example. Water is unique in that, at 4° C., as it gets cooler, it expands and becomes lighter, so the colder water remains at the surface where it continues to cool until it freezes, which explains why bodies of water freeze from the top down. However, while the top surface of the water may be freezing, water a short distance below the surface may still be at 4° C. Therefore, in order to be effective, a deicer with a submerged thermometer typically activates above 4° C.

Further, deicers may be designed with a thermostat hysteresis of 8-10° C. in order to ensure that heat travels to the far reaches of the tank before the deicer deactivates. Therefore, deicers may be configured to activate around 6° C. and heat the water until the water reaches a temperature of or around 15° C. The deicer may then deactivate, at which point the water cools. When the water temperature reaches 6° C., the deicer re-activates.

However, because of the increased heat loss from the drinking trough, the water therein may be at 0° C. and freezes before the water temperature at the deicer inside the valve chamber reaches 6° C. Thus, for a deicer to be used in a multi-chambered waterer, it may be desirable to set the thermostat to switch the deicer on and off at higher temperatures. For instance, if the thermostat is set to activate the heating element at 10° C., the water temperature in the drinking trough may still be at 4° C. The result is to provide a buffer so that heat may be supplied to the water in time to let it spread throughout the tank.

Further, in order to keep water ice-free in cold conditions, heat is supplied to the water faster than it is lost. A typical 100 gallon, un-insulated, plastic stock tank at −12° C. with no wind loses heat at a rate of around 400 watts. Therefore, a deicer rated at 250 watts in that tank may not keep the water from freezing. Also, because the rate of heat loss compared to the rate of heat input is the determining factor, wind chill is taken into account. Therefore, the same stock tank at −12° C. with a 20 MPH wind may lose heat at a rate of 600 watts. As such, even a 500 watt deicer may not keep prevent ice from forming.

Several factors may affect the flow of heated water through a water passage into a drinking trough. One factor is the size of the water passage itself. A second factor is the relative temperatures of the cool and warm water. The buoyancy of water at 15° C., for example, is significantly greater if the surrounding water is at 6° C. than it would be if the surrounding water was at 13° C. Therefore, the water flow—and, consequently, heat transfer—through the passage is the greatest in the time immediately after the deicer activates. A third factor is the agitation of the water by wind, which creates eddy currents within the water that promote liquid movement through the water passage. Therefore, while wind increases the wind chill that drains heat from the drinking trough, it also encourages heat transfer from the deicer.

Suppose an automatic waterer is located outside, and the ambient air temperature is −20° C., and a wind blowing at 20 MPH, thereby yielding a wind chill factor of −30° C. When the deicer activates, it will heat the water in the float chamber, and then start heating the drinking trough. However, because the water is losing heat faster due to wind chill, it takes longer for the body of water in the drinking trough to be heated. As such, the difference in temperature between the water in the drinking trough and the heated water remains large for a significant time which, in turn, increases the water movement due to buoyancy of the warm water. Also, the wind agitates the water thereby pushing more cold water to the deicer while also increasing the flow of the warmed water away from the deicer. As such, a zone of warm water may be prevented from forming around the deicer that would otherwise deactivate the deicer before a significant amount of heat is delivered to the drinking trough. Therefore, the deicer remains active and heat is spread throughout the drinking trough, thereby reducing the chance that the water will freeze.

In an alternate scenario, suppose the automatic waterer is located inside a shed where the ambient air temperature is −2° C. and no wind is present. In this scenario, heat is lost from the drinking trough at a relatively low rate. The heated water around the deicer rises in the float chamber until it is filled, and then starts to spill into the drinking trough. However, without the wind producing eddy currents in the water, the warmed water moves slowly away from the deicer. If the warmed water does not move away fast enough, the thermostat of the deicer may sense the warmer temperature and deactivate the deicer. Thus, the deicer may deactivate before any significant heat has been delivered to the drinking trough and the water therein may freeze. This result may be counterintuitive because if a deicer kept the drinking trough unfrozen at −20° C. with a 20 MPH wind, one would expect that the deicer would also keep the drinking trough unfrozen in a much less extreme case at −2° C. and no wind. Therefore, when the water freezes in the drinking trough in the second scenario, one may suspect a defective deicer as the reason for the freezing when the actual reason is solely due to the construction of the automatic waterer.

Accordingly, embodiments of the present disclosure provide an automatic watering system and method that efficiently heats and circulates water movement between a first chamber, such as a float or valve chamber, and a second chamber, such as a drinking chamber (for example, a drinking trough).

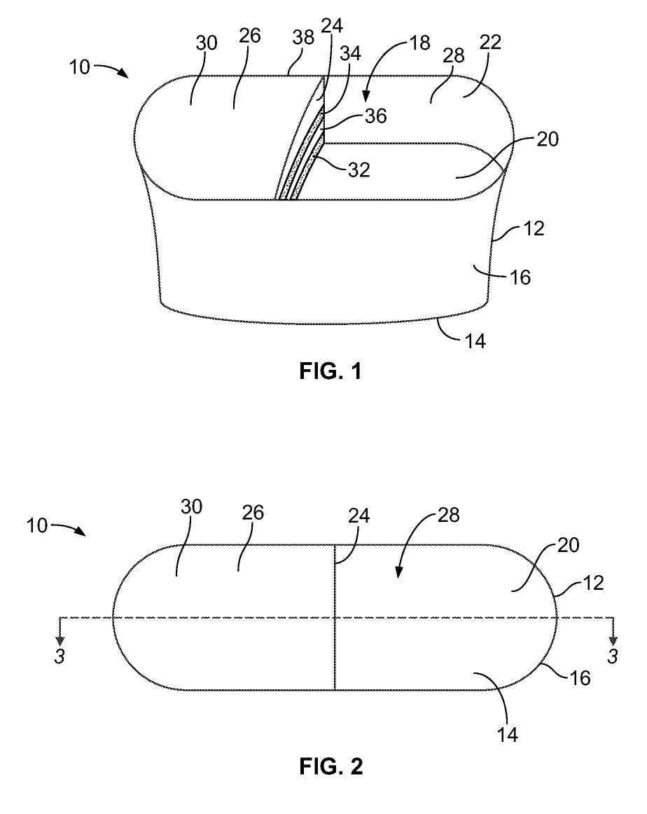

FIG. 1 illustrates a perspective top view of an automatic watering system, or waterer 10, according to an embodiment of the present disclosure. The system 10 may include may include a water-retaining vessel 12, such as a tank, bucket, bowl, basin, or the like having a base 14 that connects to an upstanding outer circumferential wall 16. A water-retention chamber 18 is defined between an upper surface 20 of the base 14 and an inner surface 22 of the wall 16.

An upstanding partition 24 extends between portions of the wall 16, such as opposite sides or ends of the wall 16. The partition 24 divides the water-retaining vessel 12 between a valve chamber 26, and an open drinking chamber 28, such as a drinking trough. The valve chamber 26 contains a valve, such as a float valve, connected to a water source. The valve chamber 26 may be closed by a cover 30. Alternatively, the valve chamber 26 may not include the cover 30.

The partition 24 may be an upstanding, vertical wall that is perpendicular to the plane of the upper surface 20 of the base 14. The partition 24 may include a first water passage 32, such as a water inlet passage (in that cool water enters the valve chamber 26 through the water inlet passage), and a second water passage 34, such as a water outlet passage (in that warm water exits the valve chamber through the water outlet passage). The first water passage 32 may be one or more openings at a first level formed through the partition 24 proximate to the upper surface 20 of the base 14. For example, the first water passage 32 may extend from the upper surface 20 of the base 14 to a height of, above, or below, a height of a deicer that is supported by the base 14.

The second water passage 34 may be spaced apart from first water passage 32 by a separating panel 36. The second water passage 34 may be one or more openings at a second level formed through the partition 24. As shown, the second water passage 34 may be above the first water passage 32. The second water passage 34 may be positioned above a water outlet of a deicer within the valve chamber 26. The second water passage 34 may extend from an upper edge of the separating panel 36 to a level that is below an upper edge 38 of the wall 16. Alternatively, the second water passage 34 may extend from the upper edge of the separating panel to the level of the upper edge 38.

FIG. 2 illustrates a top plan view of the automatic watering system 10. As shown, the water-retaining vessel 12 may be oval shaped. Alternatively, the water-retaining vessel 12 may be various other shapes and sizes. For example, the water-retaining vessel 12 may have a circular, rectangular, triangular, irregular arcuate, or other such axial cross-section. The partition 24 may divide the water-retaining vessel 12 such that the valve chamber 26 is generally the same volume as the drinking chamber 28. Alternatively, the partition 24 may be located at various other areas of the water-retaining vessel 12 such that the volume of the valve chamber 26 is greater or less than that of the drinking chamber 28.

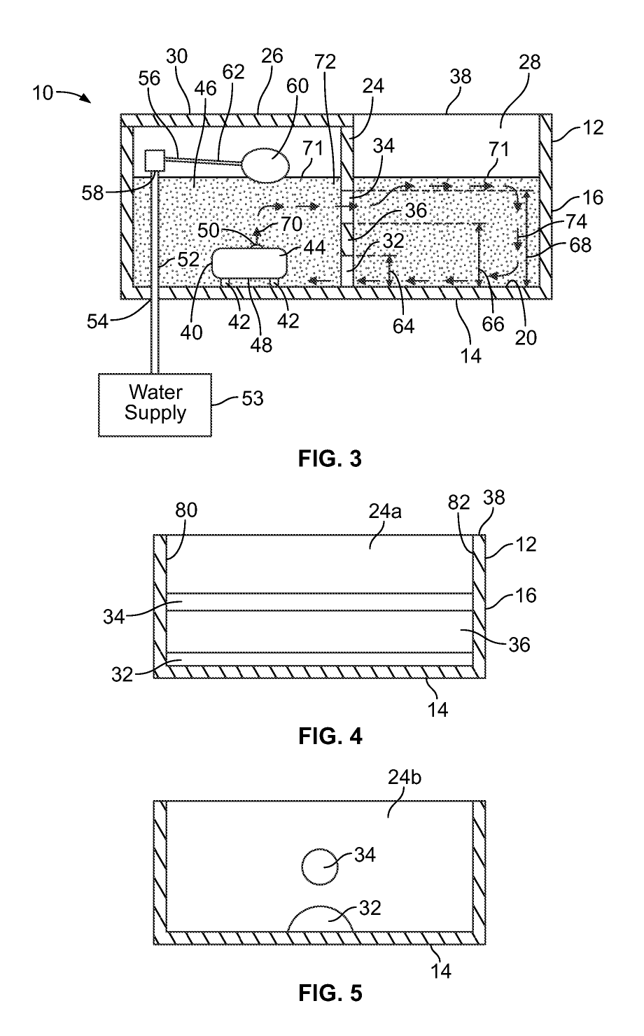

FIG. 3 illustrates a transverse cross-sectional view of the automatic watering system 10 through line 3-3 of FIG. 2, according to an embodiment of the present disclosure. A deicer 40 may be positioned within the valve chamber 26. The deicer 40 may include supports 42, such as legs, post, studs, columns, braces, ribs, or the like, that support a main body 44 above the upper surface 20 of the base 14. The main body 44 includes a heater configured to heat water 46 within the vessel 12. The heater is operatively connected to a temperature sensor, such as a thermostat, that is configured to activate and deactivate the heater based on detected water temperature thresholds. The main body 44 includes a water inlet 48 that is configured to draw the water 46 into the main body 44, such as through a pump. The water that passes into the main body 44 may be heated and ejected through a water outlet 50, which may be at a top of the deicer 40.

A water conduit 52 may extend into the valve chamber 26 through an opening 54 formed through the base 14. The water conduit 52 connects to a water supply 53, such as a faucet, spigot, or the like. Optionally, the water supply 53 may simply connect to the opening 54, without the use of the water conduit 52. Water from the water supply 53 is supplied to the vessel 12 via the water conduit 52 (and/or the opening 54).

A water-sensing mechanism, such as a valve 56, is operatively connected to a water supply outlet 58 that is in communication with the water supply 53. The valve 56 is configured to open when the water 46 within the tank drops below a certain level, and close when the water 46 within the tank reaches and/or exceeds the certain level. The valve 56 may include a float 60 operatively connected to a link 62 that connects to the water supply outlet 58. The float 60 is configured to float on the water 46. As such, the height of the float 60 is dictated by the level of the water 46 within the vessel 12. When the float 60 drops below a certain level, the link 62 opens a valve member positioned over or on the water supply outlet 58. Conversely, when the float 60 moves above the certain level, the link 62 closes the valve member positioned over on the water supply outlet 58. While the valve 56 is described as including the float 60 and the link 62, various other valves that are configured to open and close based on the level of the water 46 within the vessel 12 may be used.

As shown, the first water passage 32 may extend from the upper surface 20 of the base 14 to a height 64 that may be below the water outlet 50 of the deicer 40. Alternatively, the height 64 may be greater or less than shown.

The second water passage 34 is positioned above the first water passage 32. The second water passage 34 may extend from a height 66 that is above the water outlet 50 and main body 44 of the deicer 40 to a height 68 that is below the water supply outlet 58. Alternatively, the height may be greater or less than shown. The second water passage 34 may be formed through the partition 24 such that when the water 46 is at its lowest level prior to the valve 56 to open (in order to allow water to pass out of the water supply outlet 58 into the valve chamber 26), the second, or upper water passage 34 may be completely submerged.

In operation, the deicer 40 heats the water 46, which then becomes lighter and flows upward in the direction of arrow 70, thereby displacing colder water above it. The warmed water collects proximate to a top level 71 of the total water volume until its lower boundary moves downward to level 72 proximate to a top of the second water passage 34, where the warmed water then spills into the drinking chamber 28 through the second water passage 34. The warmed water within the drinking chamber 28 collects at the top level 71 (within drinking chamber 28), thereby displacing colder water. The colder water is then forced downward in the direction of arrow 74, and flows to the deicer 40 through the first or lower water passage 32. Once the layer of warmed water at the top level 71 within the drinking chamber 28 extends downward to level 72, the lower boundary of the warmed water in the valve chamber 26 and the drinking chamber 28 is the same, and both simultaneously move downward in the chambers 26 and 28 as the water 46 is heated by the deicer 40. Meanwhile, warmed water is generally prevented from congregating around the deicer 40 because the warmed water is continually being replaced by colder water from the drinking chamber 28. Therefore, heat transfer serves to prevent localized heating of the water around the deicer 40, thereby keeping the deicer 40 active until heat is uniformly spread throughout both the valve chamber 26 and the drinking chamber 28.

Besides providing improved convection between the two chambers 26 and 28, the positioning of the second water passage 34 below the lowest level that the water may reach during operation of the valve 56 serves to trap a body of water within the valve chamber 26 above the upper or second water passage 34. This water transfers heat to the air in the valve chamber 26 as it is continually supplied with heat from below. By heating the air in the valve chamber 26, the deicer 40 also keeps the valve 56 from freezing over.

Because the heated water can rise in the valve chamber 26 and escape into the drinking chamber 28 while colder water is forced from the drinking chamber 28 to the deicer 40, the heat transfer due to convection is optimized and does not rely upon external agitation of the water by wind. Therefore, the drinking chamber 28 remains deiced even on days when the air temperature is only a few degrees below freezing with no wind present.

As shown, the deicer 40 may be positioned within the valve chamber 26. Alternatively, the deicer 40 may be positioned within the drinking chamber 28. However, by placing the deicer 40 in the valve chamber 26, the deicer 40 is protected from being engaged by an animal that drinks from the drinking chamber 28. The deicer 40 may be a sinking deicer that sinks to the bottom of the vessel 12 and is supported by the base 14. Alternatively, the deicer 40 may be a floating deicer, or a plug deicer, for example.

FIG. 4 illustrates a front view of a partition 24a, according to an embodiment of the present disclosure. As shown, the first and second water passages 32 and 34, respectively, may be linear, rectangular shaped openings that extend between a first lateral portion 80 to a second lateral portion 82 of the circumferential wall 16. Optionally, the first and second water passages 32 may extend from lesser portions than shown in FIG. 4. Also, alternatively, the first water passage 32 may be larger than the second water passage 34, or vice versa.

FIG. 5 illustrates a front view of a partition 24b, according to an embodiment of the present disclosure. As shown, the first water passage 32 may be a semi-circular opening formed proximate to the base 14, while the second water passage 34 may be a circular opening formed above the first water passage 32. Optionally, both the first and second water passages 32 and 34 may be sized as circles or semi-circles. Also, alternatively, the first and second water passages 32 and 34 may be the same size, or one may be larger than the other. Further, the water passages 32 and 34 may be sized and shaped differently than shown.

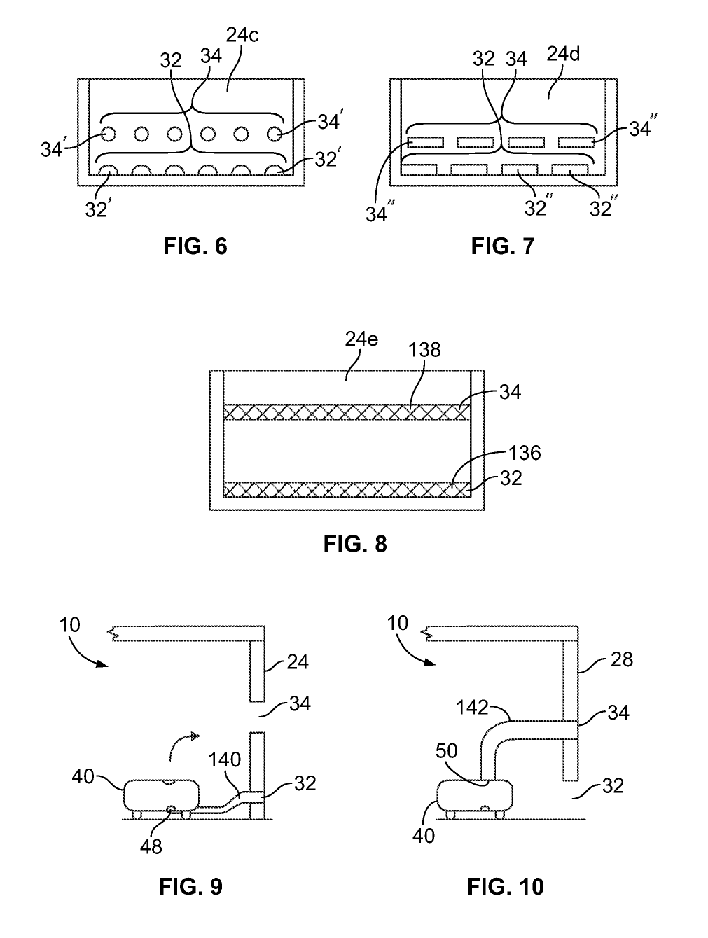

FIG. 6 illustrates a front view of a partition 24c, according to an embodiment of the present disclosure. The first water passage 32 may include a plurality of aligned openings 32′ at a first level (for example, a first height above the base 14), while the second water passage 34 may include a plurality of aligned openings 34′ at a second level (for example, a second height above the base 14). More or less openings 32′ and 34′ may be used. Further, the openings 32′ and 34′ may be sized and shaped differently than shown.

FIG. 7 illustrates a front view of a partition 24d, according to an embodiment of the present disclosure. The first water passage 32 may include a plurality of aligned rectangular open-ended slots 32″, while the second water passage 34 may include a plurality of aligned rectangular open-ended slots 34″. More or less slots 32″ and 34″ may be used. Further, the slots 32″ and 34″ may be sized and shaped differently than shown.

FIG. 8 illustrates a front view of a partition 24e, according to an embodiment of the present disclosure. As shown, each water passage 32 and 34, respectively, may include a screen 136 and 138, respectively, which is configured to allow water to pass through openings formed therethrough, but prevent large solid objects from passing therethrough. In this manner, the screens 136 and 138 prevent debris from passing between chambers. For example, the screens 136 and 138 prevent debris from passing from a drinking chamber into a valve chamber in which the deicer is retained. Accordingly, the screens 136 and 138 may prevent debris from passing into the deicer.

The screens 136 and 138 may be wire meshes, for example. Each screen 136 and 138 may be secured on, over, and/or within the first and second water passages 32 and 34, respectively, such as on one or both sides of the partition 24e. Optionally, the screens 136 and 138 may be positioned within the first and second water passages 32 and 34, respectively (such as extending between interior portions that are between outer surfaces of the partition 24e).

Any of the embodiments described above, such as shown in FIGS. 1-7, may include screens over and/or within the first and second water passages 32 and 34.

FIG. 9 illustrates a transverse cross-sectional view of the deicer 40 in relation to the partition 24 of the automatic watering system 10, according to an embodiment of the present disclosure. As shown, a water transfer conduit 140, such as a flexible or rigid tube, pipe, or the like, may extend from the first water passage 32 to the water inlet 48 of the deicer 40. The water transfer conduit 140 is configured to channel cool water directly to the water inlet 48. The water transfer conduit 140 may be used with any of the embodiments described above.

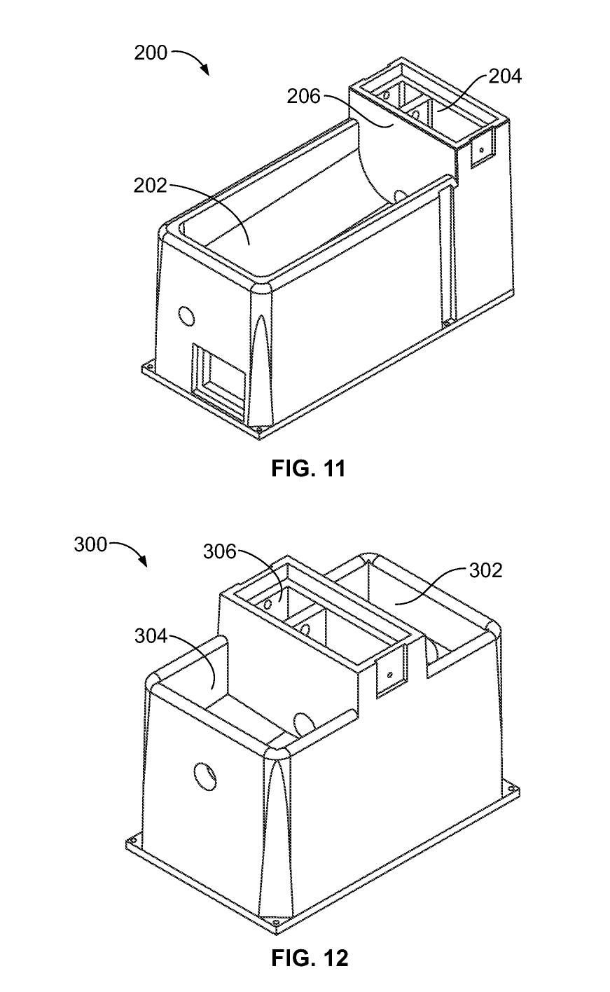

FIG. 10 illustrates a transverse cross-sectional view of the deicer 40 in relation to the partition 24 of the automatic watering system 10, according to an embodiment of the present disclosure. A water transfer conduit 142, such as a flexible or rigid tube, pipe, or the like, may extend from the water outlet 50 of the deicer 40 to the second water passage 34. The water transfer conduit 142 is configured to channel warm water directly from the water outlet 50 to the drinking chamber 28. The water transfer conduit 142 may be used with any of the embodiments described above.

FIG. 11 illustrates a perspective top view of an automatic watering system 200, according to an embodiment of the present disclosure. The system 200 may include may include a drinking chamber 202 and a valve chamber 204, similar to as described above. A partition 206 may separate the drinking chamber 202 from the valve chamber 204. As shown, the valve chamber 204 is positioned at an end of the system 200.

FIG. 12 illustrates a perspective top view of an automatic watering system 300, according to an embodiment of the present disclosure. The system 300 may include first and second drinking chambers 302 and 304 positioned on opposite ends of a valve chamber 306. Partitions may separate the drinking chambers 302 and 304 from the valve chamber 306.

Certain embodiments of the present disclosure provide a water-retaining vessel including a base connected to an upstanding wall. A water-retention chamber is defined between the base and the upstanding wall. The water-retaining vessel is configured to retain water within the water-retaining chamber. A partition is positioned within the water-retaining vessel. The partition separates the water-retaining chamber into a valve chamber and a drinking chamber. The partition includes at least one water passage having a first portion at a first level and a second portion at a second level that is above the first level. For example, a single water passage may have a first portion that is at or above a level of an outlet of a deicer, and a second portion that is at or below a level of an inlet of a deicer. The first portion may be at a first height, while the second portion may be at a second height which is above or below the first height. The deicer outlet may be on top of the deicer, while the inlet is at a lower portion of the deicer, or vice versa, for example. Optionally, the at least one water passage may include two separate and distinct water passages separated by an intermediate panel, for example.

The water passage(s) may be configured to circulate the water through the first portion and the second portion in a unidirectional loop. For example, water may be circulated from the valve chamber through the second portion of a single water passage into the drinking chamber, and then return from the drinking chamber through the first portion of the single water passage back to the valve chamber. Alternatively, water may be circulated from the valve chamber through the first portion of the single water passage into the drinking chamber, and then return from the drinking chamber through the second portion of the single water passage back to the valve chamber.

As described above, embodiments of the present disclosure provide automatic watering systems that efficiently heat water within a drinking chamber and a float chamber. Embodiments of the present disclosure may include two separate and distinct, vertically-separated water passages positioned within a partition that separates a valve chamber from a drinking chamber. It has been found that embodiments of the present disclosure increase thermal transfer between portions of water through convection.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An automatic watering system, comprising:
a water-retaining vessel including a base connected to an upstanding wall, wherein a water-retention chamber is defined between the base and the upstanding wall, and wherein the water-retaining vessel is configured to retain water within the water-retaining chamber;
a partition positioned within the water-retaining vessel, wherein the partition separates the water-retaining chamber into a valve chamber and a drinking chamber, wherein the partition includes a first water passage at a first level and a second water passage at a second level that differs from the first level;
a valve operatively connected to a water supply outlet within the valve chamber, wherein the valve is configured to be moved between an open position in which the water supply outlet is opened, and a closed position in which the water supply outlet is closed; and
a deicer within one of the valve and drinking chambers, wherein the deicer is configured to heat the water within both the valve and drinking chambers.

2. The automatic watering system of claim 1, wherein the second level is above the first level.

3. The automatic watering system of claim 1, wherein the first level extends from an upper surface of the base to a lower edge of a separating panel of the partition.

4. The automatic watering system of claim 1, wherein the second level extends from a first height that is above a water outlet of the deicer to a second height that is below the water supply outlet.

5. The automatic watering system of claim 1, wherein the second water passage is configured to be completely submerged by the water when the water is at a lowest level prior to the valve moving to the open position.

6. The automatic watering system of claim 1, wherein the deicer is a sinking deicer including a heating element operatively connected to a thermostat.

7. The automatic watering system of claim 1, wherein one or both of the first and second water passages includes one or more linear openings formed through the partition.

8. The automatic watering system of claim 1, wherein one or both of the first and second water passages includes one or more arcuate openings formed through the partition.

9. The automatic watering system of claim 1, further comprising a screen positioned on, over, or within one or both of the first and second water passages.

10. The automatic watering system of claim 1, further comprising one or both of a first water transfer conduit that extends from the first water passage to a water inlet of the deicer, or a second water transfer conduit that extends from a water outlet of the deicer to the second water passage.

11. An automatic watering system, comprising:
a water-retaining vessel including a base connected to an upstanding wall, wherein a water-retention chamber is defined between the base and the upstanding wall, and wherein the water-retaining vessel is configured to retain water within the water-retaining chamber;
a partition positioned within the water-retaining vessel, wherein the partition separates the water-retaining chamber into a valve chamber and a drinking chamber, wherein the partition includes at least one water passage having a first portion at a first level and a second portion at a second level that is above the first level, and wherein the at least one water passage is configured to circulate the water through the first portion and the second portion in a unidirectional loop.

12. The automatic watering system of claim 11, wherein the at least one water passage includes a lower water passage at the first level and an upper water passage at the second level that is above the first level.

13. The automatic watering system of claim 11, further comprising a valve operatively connected to a water supply outlet within the valve chamber, wherein the valve is configured to be moved between an open position in which the water supply outlet is opened, and a closed position in which the water supply outlet is closed.

14. The automatic watering system of claim 12, wherein the upper water passage is configured to be completely submerged by the water when the water is at a lowest level prior to a valve moving to an open position.

15. The automatic watering system of claim 11, further comprising a deicer within one of the valve and drinking chambers, wherein the deicer is configured to heat the water within both the valve and drinking chambers.

16. The automatic watering system of claim 11, wherein the first level extends from an upper surface of the base to a lower edge of a separating panel of the partition.

17. The automatic watering system of claim 12, wherein one or both of the lower and upper water passages includes one or more linear or arcuate openings formed through the partition.

18. The automatic watering system of claim 11, further comprising a screen positioned on, over, or within the at least one water passage.

19. The automatic watering system of claim 12, further comprising one or both of a first water transfer conduit that extends from the lower water passage to a water inlet of the deicer, or a second water transfer conduit that extends from a water outlet of the deicer to the upper water passage.

20. An automatic watering system, comprising:
a water-retaining vessel including a base connected to an upstanding wall, wherein a water-retention chamber is defined between the base and the upstanding wall, and wherein the water-retaining vessel is configured to retain water within the water-retaining chamber;
a partition positioned within the water-retaining vessel, wherein the partition separates the water-retaining chamber into a valve chamber and a drinking chamber, wherein the partition includes a lower water passage at a first level and an upper water passage at a second level that is above the first level, wherein the first level extends from an upper surface of the base to a lower edge of a separating panel of the partition, wherein one or both of the first and second water passages includes one or more linear or arcuate openings formed through the partition;
a valve operatively connected to a water supply outlet within the valve chamber, wherein the valve is configured to be moved between an open position in which the water supply outlet is opened, and a closed position in which the water supply outlet is closed, the second water passage is configured to be completely submerged by the water when the water is at a lowest level prior to the valve moving to the open position; and
a deicer within one of the valve and drinking chambers, wherein the deicer includes a water inlet and a water outlet, wherein the deicer is configured to heat the water within both the valve and drinking chambers, wherein the second level extends from a first height that is above the water outlet of the deicer to a second height that is below the water supply outlet.
